(19) United States
(12) Patent Application Publication
(10) Pub. No.: US 2023/0371153 A1
(43) Pub. Date: Nov. 16, 2023

(54) SYSTEMS AND METHODS FOR INTERACTIVE LIGHTING CONTROL

(71) Applicant: SIGNIFT HOLDING B.V., EIHDHOVEN (NL)

(72) Inventor: ABHISHEK MURTHY, ARLINGTON, MA (US)

(21) Appl. No.: 18/029,252

(22) PCT Filed: Sep. 23, 2021
(86) PCT No.: PCT/EP2021/076175

§ 371 Date: Mar. 29, 2023

Related U.S. Application Data
(60) Provisional application No. 63/086,706, filed on Oct. 2, 2020.

(30) Foreign Application Priority Data
Oct. 12, 2020 (EP) 20201203.5

(51) Int. Cl. H05B 47/115; H05B 47/155; A01G 9/24

(52) U.S. Cl. CPC H05B 47/115; H05B 47/155; A01G 9/249; F21S 4/10

(57) ABSTRACT

Systems and methods for controlling and interacting with plant lighting are provided. The methods include: determining or receiving location information indicative of relative locations of a plurality of sensors arranged around a portion of a plant, wherein the plurality of sensors are distributed among a plurality of lighting elements and the plurality of sensors are configured to capture sensor data for at least one parameter of the plant; measuring sensor data for the at least one parameter of the plant; annotating, by a processor, the sensor data with the location information of the plurality of sensors and timestamp information; analyzing, by the processor, the annotated sensor data; and determining a state of the plant based on the sensor data. Methods further include receiving, by a lighting controller, user input corresponding to the state of the plant and controlling the lighting elements based on the user input.

### FIELD OF THE DISCLOSURE

The present disclosure is directed generally to interactive lighting control, particularly to the controlling and creating of light effects such as the tuning of light scenes based on a determined state of a plant.

### BACKGROUND

Decorative tree lighting typically includes strips of lights that are hung and wrapped on trees and other plants for decorative purposes. Such tree lighting is often used for festive occasions like Christmas and Diwali and is usually controlled by simple timing-based controllers that execute pre-defined lighting recipes. Modern lighting systems may allow the user to set different recipes via mobile-phone interfaces.

Some tree lighting systems include lighting elements that wrap around the trunks of the tree using a mesh-based wire arrangement. The mesh-based wire arrangement is always in contact with the trunk. Biomimetic textile-based biosensors are available to monitor, in vivo and in real-time, variations in the solute content of plant sap. There is no detectable effect on the plant's morphology from the biosensor. However, such biosensors are inserted directly into the tissue of the plant.

There is a need in the art to improve interactive tree lighting control systems using user-friendly sensors.

### SUMMARY OF THE INVENTION

The present disclosure is directed to inventive systems and methods for interactive lighting control using plant lighting and surface-based sensors to capture sensor data indicative of a state of the plant. Generally, embodiments of the present disclosure are directed to improved systems and methods for determining a state of a plant using surface-based sensors. Applicant has recognized and appreciated that it would be beneficial to exploit the existing structure of large-scale plant lighting using contact-based sensing technologies to determine a state of the plant. Additionally, Applicant has recognized and appreciated that it would be beneficial to control the plant lighting based on data collected from the contact-based sensors and/or user preferences.

Generally, in one aspect, a system for controlling plant lighting is provided. The system includes a plurality of sensors arranged around a portion of a plant, wherein the plurality of sensors are distributed among a plurality of lighting elements and the plurality of sensors are configured to capture sensor data for at least one parameter of the plant; and a processor associated with the plurality of sensors and the plurality of lighting elements. The processor is configured to determine or receive location information indicative of relative locations of the plurality of sensors around the portion of the plant; receive, from the plurality of sensors, sensor data for the at least one parameter of the plant; annotate the sensor data with the location information of the plurality of sensors and timestamp information; analyze the annotated sensor data; and determine a state of the plant based on the annotated sensor data.

According to an embodiment, the system further includes a lighting controller associated with the processor, wherein the lighting controller is configured to receive user input comprising a lighting effect corresponding to the state of the plant and control at least one of the plurality of lighting elements to provide the lighting effect based on the user input.

According to an embodiment, the processor is further configured to: receive, from the plurality of sensors, initial sensor data for the at least one parameter of the plant; and automatically determine the location information based on the initial sensor data received.

According to an embodiment, the processor is further configured to: receive an image of the plant; and receive, from a user, the location information indicative of the relative locations of the plurality of sensors within the image.

According to an embodiment, the plurality of sensors are contact-based sensors.

According to an embodiment, the plurality of sensors are ultrasonic sensors.

According to an embodiment, the processor is configured to classify the state of the plant based on a time-series classification algorithm.

Generally, in another aspect, a method for controlling plant lighting is provided. The method includes: determining or receiving location information indicative of relative locations of a plurality of sensors arranged around a portion of a plant, wherein the plurality of sensors are distributed among a plurality of lighting elements and the plurality of sensors are configured to capture sensor data for at least one parameter of the plant; measuring, by the plurality of sensors, sensor data for the at least one parameter of the plant; annotating, by a processor, the sensor data with the location information of the plurality of sensors and timestamp information; analyzing, by the processor, the annotated sensor data from the plurality of sensors; and determining, by the processor, a state of the plant based on the annotated sensor data.

According to an embodiment, the method further includes: receiving, by a lighting controller, user input comprising a lighting effect corresponding to the state of the plant; and controlling, by the lighting controller, at least one of the plurality of lighting elements based on the user input.

According to an embodiment, the determining or receiving step includes: collecting, by the plurality of sensors, initial sensor data for the at least one parameter of the plant; and automatically determining the location information based on the initial sensor data collected.

According to an embodiment, the determining or receiving step includes: receiving an image of the plant; and receiving, from a user, the location information indicative of relative locations of the plurality of sensors within the image.

According to an embodiment, the measuring step includes measuring the sensor data with contact-based sensors.

According to an embodiment, the measuring step includes measuring the sensor data with ultrasonic sensors.

According to an embodiment, the step of determining the state of the plant includes classifying the state of the plant based on a time-series classification algorithm.

According to an embodiment, the method further includes: receiving user input comprising a lighting effect corresponding to an aggregation of a plurality of states of the plant, the plurality of states of the plant comprising the state of the plant; and controlling, by a lighting controller, at least one of the plurality of lighting elements based on the user input.

In various implementations, the processor described herein may take any suitable form, such as, one or more processors or microcontrollers, circuitry, one or more controllers, a field programmable gate array (FGPA), or an application-specific integrated circuit (ASIC) configured to execute software instructions. Memory associated with the processor may take any suitable form or forms, including a volatile memory, such as random-access memory (RAM), static random-access memory (SRAM), or dynamic random-access memory (DRAM), or non-volatile memory such as read only memory (ROM), flash memory, a hard disk drive (HDD), a solid-state drive (SSD), or other non-transitory machine-readable storage media. The term “non-transitory” means excluding transitory signals but does not further limit the forms of possible storage. In some implementations, the storage media may be encoded with one or more programs that, when executed on one or more processors and/or controllers, perform at least some of the functions discussed herein. It will be apparent that, in embodiments where the processor implements one or more of the functions described herein in hardware, the software described as corresponding to such functionality in other embodiments may be omitted. Various storage media may be fixed within a processor or may be transportable, such that the one or more programs stored thereon can be loaded into the processor so as to implement various aspects as discussed herein. Data and software, such as the algorithms or software necessary to analyze the data collected by the sensors, an operating system, firmware, or other application, may be installed in the memory.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the present disclosure.

FIG. 1 is an example schematic depiction of an interactive plant lighting system in accordance with aspects of the present disclosure;

FIG. 2 is an example schematic depiction of a wire mesh arrangement including lighting elements and sensors in accordance with aspects of the present disclosure;

FIG. 3 is another example schematic depiction of a wire mesh arrangement including lighting elements and sensors in accordance with aspects of the present disclosure;

FIG. 4 is an example schematic depiction of a lighting controller system in accordance with aspects of the present disclosure; and

FIG. 5 is an example flowchart showing methods for determining a state of a plant and controlling and/or interacting with a plant lighting system in accordance with aspects of the present disclosure.

### DETAILED DESCRIPTION OF EMBODIMENTS

The present disclosure describes various embodiments of systems and methods for interacting with plant lighting using surface-based sensors to capture data indicative of a parameter of the plant. Applicant has recognized and appreciated that it would be beneficial to capture plant data (e.g., water transport measurements) using a plant-wide sensor system integrated with plant lighting and control the lighting based on the captured plant data. The present disclosure describes various embodiments of systems and methods for providing a distributed network of sensors by making use of illumination devices that are already arranged in a wire-mesh arrangement. Such existing infrastructure can be used as a backbone for the additional detection functionalities described herein.

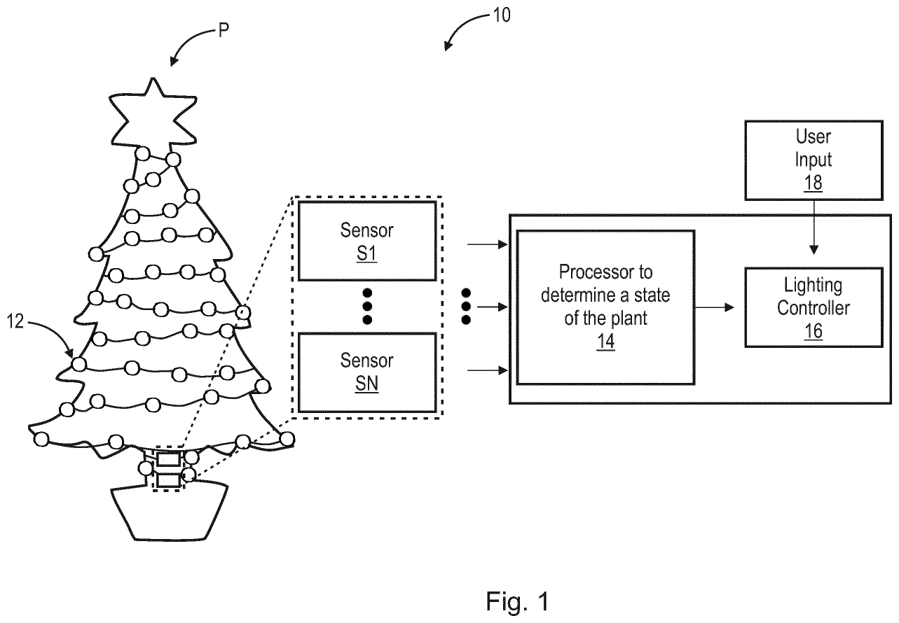

Referring to FIG. 1, an exemplary system 10 is shown including a plurality of sensors S1 . . . SN where N is an integer greater than 1 indicating the number of sensors in the system. The plurality of sensors S1 . . . SN are distributed among a plurality of lighting elements 12 and the plurality of sensors S1 . . . SN are configured to capture sensor data for at least one parameter of the plant P. The plurality of sensors S1 . . . SN and lighting elements 12 are wrapped around at least a portion of plant P. In FIG. 1, at least some of the sensors are contacting the trunk of the tree. However, it should be appreciated that the sensors can be placed in contact with any portion of the plant including but not limited to the roots, stem, branches, leaves, flowers, fruits, etc.

In embodiments, the sensors include at least some connected hydration sensors contacting various parts of the plant P. Water is typically transported through the xylem tissues present in the trunk of the plant during nighttime. Thus, the connected hydration sensors can be configured to measure water transport at night times. In embodiments where the time of day is relevant, the sensors can include a clock, a daylight sensor, or any other suitable means for determining day from night. The clock, daylight sensor, or other means can also be in communication with the sensors and/or other components of the system (e.g., processor 14). In embodiments, the sensors include at least some connected air quality detection sensors contacting various parts of the plant P to monitor the emission of gases such as carbon dioxide. The connected air quality detection sensors and connected hydration sensors can be used alternatively or in combination. Instead of or in addition to the connected hydration and air quality sensors, the sensors include at least some ultrasonic sensors to determine how much water is within the plant. For example, the ultrasonic sensors can be positioned on either side of the trunk of the plant and the signals emitted from one side and received at the other side can be used to determine how much water is in between. In embodiments, the sensors include some contact-less sensors such as optical sensors arranged at a distance from the plant. The connected sensors refer to any interconnection of two or more devices (including controllers or processors) that facilitates the transmission of information (e.g., for device control, data storage, data exchange, etc.) between the devices coupled to a network. Any suitable network for interconnecting two or more devices is contemplated including any suitable topology and any suitable communication protocols.

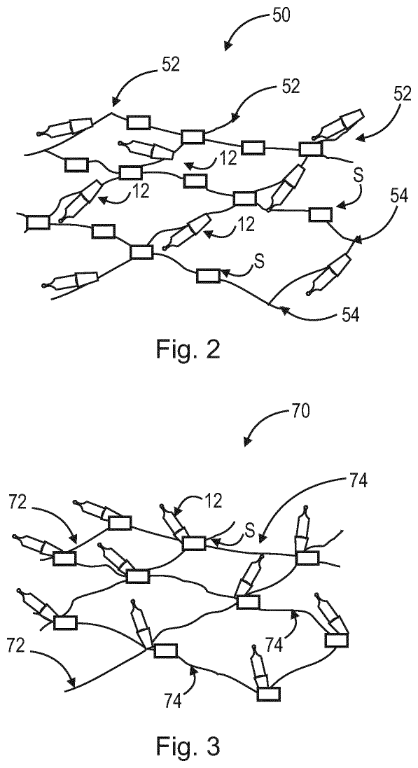

As shown schematically in FIGS. 2 and 3, the plurality of sensors S1 . . . SN and lighting elements 12 can be arranged along or on a wire mesh arrangement 50, 70. Such arrangements ensure that the sensors and lighting elements are stably supported in their placement when positioned on plant P. For example, the sensors and lighting elements can rest against the surfaces of the portion of the plant and each sensor is prevented from moving circumferentially or laterally or longitudinally along the surfaces of the portion of the plant due to the surrounding wire structure. It should be appreciated that any suitable alternative arrangement is contemplated, such as, net, netting, web or webbing, and screen arrangements.

As shown in arrangement 50 of FIG. 2, the wires can include a plurality of longitudinal wires 52 and a plurality of lateral wires 54 that intersect the longitudinal wires. The longitudinal wires 52 and the lateral wires 54 form a plurality of closed shapes with one or more lighting elements 12 and/or one or more sensors S enclosing the interiors of the closed shapes formed by the wires. It should be appreciated that the lighting elements 12 and or the sensors S can surround all of the interiors of the closed shapes formed by the wires or any number less than the total number of the interiors of the closed shapes formed by the wires. While the embodiment shown in FIG. 2 shows the wires 52 and 54 forming a plurality of quadrilaterals, any shape is contemplated, for example, circles, triangles, any regular or irregular polygon, or any other shape (e.g., a moon), etc. The lighting elements 12 can be arranged along the longitudinal wires 52 at points between the intersections where the longitudinal wires 52 meet the lateral wires 54 as shown. In alternate embodiments, the lighting elements 12 can be arranged along the lateral wires 54 at points between the intersections where the lateral wires 54 meeting the longitudinal wires 52. It should be appreciated that the lighting elements 12 can be arranged between each two adjacent lateral wires 54 as shown or in any other suitable arrangement. The sensors S shown in FIG. 2 are arranged at points surrounding the lighting elements 12. In embodiments, they can be arranged at the intersections where the longitudinal wires 52 meet the lateral wires 52. In embodiments where the lighting elements 12 are arranged along the longitudinal wires 52, the sensors S can be arranged along the lateral wires 54 and vice versa. It should be appreciated that the sensors S can be arranged at any suitable intervals, such as, regular or irregular intervals.

As shown in arrangement 70 of FIG. 3, the wires can include a plurality of longitudinal wires 72 and a plurality of lateral wires 74 that intersect the longitudinal wires. The longitudinal wires 72 and the lateral wires 74 form a plurality of closed shapes with one or more lighting elements 12 and/or one or more sensors S enclosing the interiors of the closed shapes formed by the wires. While the embodiment shown in FIG. 3 shows the wires 72 and 74 forming a plurality of quadrilaterals, any shape is contemplated, for example, circles, triangles, any regular or irregular polygon, or any other shape, etc. The lighting elements 12 can be arranged at the points where the longitudinal wires 72 intersect the lateral wires 74 as shown. However, any alternative arrangement is contemplated and the embodiment depicted should not be construed as limiting. The sensors S shown in FIG. 3 are arranged at the same points where the longitudinal wires 72 meet or intersect the lateral wires 74. In embodiments, the sensors S can be integrated or otherwise connected to the lighting elements 12.

The system 10 also includes a processor 14 associated with the plurality of sensors S and the plurality of lighting elements 12. The processor 14 is configured to determine or receive location information indicative of relative locations of the plurality of sensors around the portion of the plant P where they are positioned as further explained below. In an embodiment, the processor 14 is configured to determine the relative locations of the plurality of sensors S on the plant P based on an automated commissioning process. In such an automated commissioning process, the processor 14 is configured to receive initial sensor data for at least one parameter of the plant P from the plurality of sensors S described herein. When a sufficient number of measurements are collected by all of the sensors S, the sensors undergo self-commissioning. This results in the processor 14 gaining an understanding of which sensors are at which locations of the plant. For example, if the sensors are activated in a sequence based on their position on the plant, such a sequence can be exploited to determine the relative positions of the sensors. Some sensors that are near the ground will provide sensor data that can be differentiated from sensor data provided by sensors that are higher up the trunk. Thus, if root sensors are activated before trunk, branch, and leaf sensors, the processor 14 can determine that the root sensors are below the trunk, branch, and leaf sensors and so on. The spatio-temporal pattern of the sensor readings can be used as input to a suitable graph-learning algorithm.

In an embodiment, the processor 14 is configured to receive the relative positions of the plurality of sensors around the plant using a manual commissioning process. In such an embodiment, for example, the processor 14 can receive an image of the plant and user input indicative of location information of the relative locations of the sensors within the image. For example, a user can assign each sensor a location within the image and that data can be used to determine relative locations among the sensors. In another example, a user can be instructed to identify each sensor in a sequence starting at a point in the image (e.g., the bottom) and ending at another point in the image (e.g., the top). Such a sequence conveys relative locations of the sensors.

The processor 14 is also configured to receive sensor data from the sensors S after the commissioning process. After commissioning is established, the sensor data is obtained depending on the parameter(s) being monitored. The processor 14 can annotate the obtained sensor data with the different parts of the plant, along with timestamp information. As used herein, the term “annotate” refers to the process of associating data from one data structure with data from another data structure. The term annotate can refer to data tagging or labeling in some embodiments. The processor can also analyze the annotated sensor data and determine a state of the plant based on the annotated sensor data. For example, when a sufficient number of measurements are collected by all of the sensors S, a time-series classification algorithm can be used to classify the state of the plant. In an embodiment, the states of the plant can include the following for a system of connected hydration sensors: “Water uptake ongoing”, “Water uptake starting”, “Water uptake complete”, etc. Different time-series classification techniques, such as, Markov models or Long Short-Term Memory artificial neural networks can be used as well.

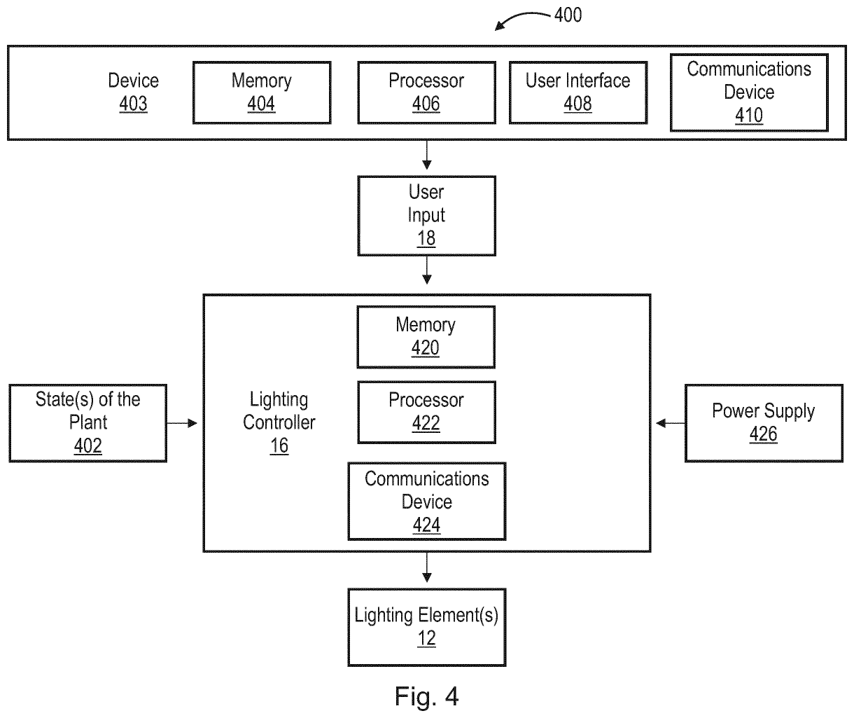

The system 10 can also include a lighting controller 16 associated with the processor 14. As shown in FIG. 4, the lighting controller system 400 is configured to receive one or more states of the plant 402 determined by the processor 14. The lighting controller 16 is also configured to receive user input 18 including one or more lighting effects that can correspond to the different states of the plant. In embodiments, a user interface (UI), for example, a graphical user interface (GUI), such as a dashboard, can be displayed to a user via an interactive electronic device 403. Example electronic devices 403 include a personal computer, a laptop computer, a smartphone, a personal data assistant (PDA), a wrist smart watch device, a head-mounted device, an ear-mounted device, a near field communication device etc. The electronic device 403 includes a memory 404, a processor 406, a user interface (e.g., a display) 408, and a communications device 410, such as a wireless network device (e.g., Wi-Fi), wireless Bluetooth device, and/or infrared transmitting unit. The memory 404 includes an operating system and one or more user applications to carry out an interactive lighting process. The electronic device 403 can include one or more devices or software for enabling communication with a user. The one or more devices can include a touch screen, a keypad, touch sensitive and/or physical buttons, switches, a keyboard, knobs, levers, a display, speakers, a microphone, one or more indicator lights, audible alarms, a printer, and/or other suitable interface devices. The user interface can be any device or system that allows information to be conveyed and/or received, and may include a graphical display configured to present to a user views and/or fields configured to receive entry and/or selection of information. The GUI enables a user to select or associate certain lighting effects preferences with certain states of the plant. The communications device 410 is configured to send user input 18 to lighting controller 16.

The one or more lighting effects of the user input 18 can include any light recipe comprising any combination of light parameters, such as, color, color temperature, saturation, brightness, intensity, etc. The light parameters can include any number of colors as well. For example, a particular state of a plant can correspond to a mixture of colors, or a mixture of a sub-set of colors. The light recipe can also convey a summary of different states the plant has exhibited throughout a period of time, such as a day. In an embodiment, the different states that the plant has exhibited over a period of time can be averaged according to any suitable process. In embodiments, different states can be applied with different weights in the averaging process depending on when the states occur during the day. For example, a particular state at night might be weighted more heavily than a particular state exhibited during the day or vice versa depending on the parameter of the plant being monitored. In embodiments, the light recipe can also convey contextual information of the user's day. The user input 18 from the electronic device 403 can be stored in memory 420.

The memory 420 can be integrated in or otherwise connected to the lighting controller 16. Each state of the plant 402 can be associated with specific lighting effects provided via user input 18 by processor 422 if the association is not already carried out by the electronic device 403. Processor 422 can be integrated in or otherwise connected to the lighting controller 16. In embodiments, lighting effects can be associated with one or more states of a plant and the associated data can be stored in memory 420. In embodiments, the associated data can be in a look up table (LUT) or any suitable alternative. Processor 422 can be configured to access such stored associated data in memory 420 when the controller 16 receives the one or more states of the plant 402.

The lighting controller 16 is also configured to control one or more of the lighting elements 12 to provide the lighting effect based on the user input 18. The lighting effect can be an intensity, one or more colors, a flashing pattern, or any other light effect property that can be altered. The lighting controller 16 can include a communications device 424, such as a wireless network device (e.g., Wi-Fi), Bluetooth device, infrared receiving unit, and so forth. Generally, light controllers include software components for configuring fixtures and designing and editing lighting scenes, and hardware components for sending control data to the fixtures. Controllers/drivers are typically sued for flashing, dimming, and color mixing lights. Example light controllers include the Video System Manager Pro, the Light System Manager (LCM) controller, and the ColorDial Pro, from Signify N.V. of Eindhoven, NL.

The communications device 424 of the lighting controller 16 is adapted to receive one or more lighting adjustment signals from the processor 422 causing the controller 16 to alter one or more lighting properties of the lighting elements 12. The lighting controller system 400 includes a power supply 426.

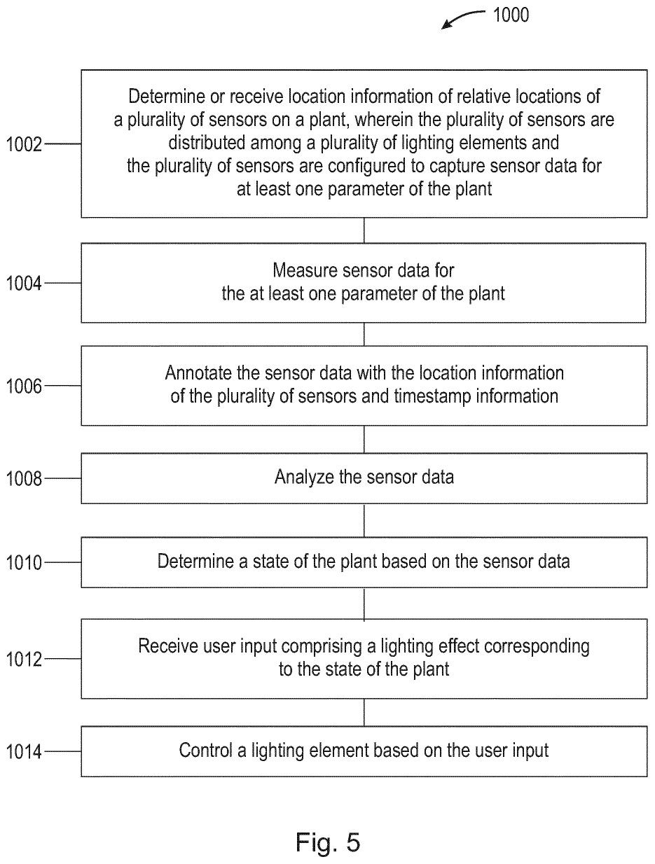

Referring to FIG. 5, a flowchart showing methods for determining a state of a plant is provided. The methods illustrated in FIG. 5 can also be used to control the lighting elements 12 corresponding to a determined state of the plant. In FIG. 5, the method 1000 begins with determining or receiving location information indicative of relative locations of a plurality of sensors wrapped around a portion of a plant in step 1002. The plurality of sensors (e.g., S1 . . . SN) are distributed among a plurality of lighting elements (e.g., 12) and the sensors are configured to capture sensor data for at least one parameter of the plant as discussed above. In embodiments where the relative locations are determined, initial sensor data can be received from the sensors and input to a commissioning process as described above. In other embodiments, the relative locations can be received manually using an image of the plant as described above.

At step 1004 of the method, the plurality of sensors measure sensor data for the at least one parameter of the plant. Such measurements can be obtained continuously, periodically, or on demand.

At step 1006 of the method, the sensor data can be annotated with location information and timestamp information.

At step 1008 of the method, the sensor data can be analyzed and at step 1010 a state of the plant can be determined based on the analyzed sensor data. The state of the plant can indicate a health status of the plant and/or indicate issues with water transport, for example. In embodiments with connected hydration sensors, the hydration measurements collected can be used to estimate water flows in the plant.

Advantageously, a plant-wide sensor system is provided that can generate information indicating a state or health status of the plant. Such described sensor systems are easy to install and do not require inserting the sensors into the tissue of the plant.

In addition to measuring water transport or other parameters of a plant, the plant-wide sensor system provides an entirely new dimension for users to interact with and control the connected lighting elements 12.

At step 1012 of the method in FIG. 5, user input (e.g., 18) can be received by a lighting controller (e.g., 16) where the user input includes at least one lighting preference that can be associated with a state of the plant. The user input can be received upon configuring the system, from the manufacturer, or at any time after configuring the system. The customization of lighting scenes for the states of the plant can occur at any time through the electronic device 403, for example. In embodiments, the user input can be different colors for the different states of the plant. In embodiments, the user input can be a single color at different intensities to differentiate among the different states of the plant. In embodiments, the user input can be a single color at different flashing patterns corresponding to different states of the plant. In embodiments, the user input comprises a lighting effect or recipe corresponding to an aggregation of a plurality of states of the plant. A plurality of states of the plant can be aggregated and summarized to convey a picture for how the plant is doing over a period of time. An average of states may provide more accurate information as to the overall health/status of the plant. An average of weighted states may provide an even more accurate depiction in embodiments.

At step 1014 of the method, the lighting controller 16 can control one or more of the plurality of lighting elements 12 based on the user input.

In embodiments with connected hydration sensors, methods can involve initializing hydration sensor readings in step 1, learning a topology of the plant based on the hydration sensor readings in step 2, continuing to obtain hydration sensor readings at different parts of the plant at step 3, and combining the hydration sensor readings to classify a state of the plant at step 4. The classification step can involve a time-series classification process. At step 5, the method can involve determining whether a state of the plant is converged. If not, the process returns to step 3 to continue obtaining hydration sensor readings at different parts of the plant. If the state of the plant is converged, the process proceeds to control the lighting elements. The lighting elements are then activated based on sensor state and any user preferences associated with the sensor state.

Advantageously, the systems and methods can be used to allow a user to customize plant lighting based on sensor data of the plant. The measurements obtained across the plant-wide sensor system can be combined with user preferences to generate different lighting scenes in the lighting controller 16. Accordingly, when the controller controls the lighting elements 12 to display a particular lighting scene based on the user input, the user can immediately appreciate what is happening with the plant when viewing the lighting scene. The user can also make changes to the lighting scenes as desired.

It should also be understood that, unless clearly indicated to the contrary, in any methods claimed herein that include more than one step or act, the order of the steps or acts of the method is not necessarily limited to the order in which the steps or acts of the method are recited.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A system for controlling plant lighting, comprising:
a plurality of lighting elements;
a plurality of sensors arranged around a portion of a plant, wherein the plurality of sensors are distributed among the plurality of lighting elements and the plurality of sensors are configured to capture sensor data for at least one parameter of the plant; and
a processor associated with the plurality of sensors and the plurality of lighting elements, wherein the processor is configured to:
determine or receive location information indicative of relative locations of the plurality of sensors around the portion of the plant using a commissioning process;
receive, from the plurality of sensors, sensor data for the at least one parameter of the plant;
annotate the sensor data with the location information of the plurality of sensors, one or more parts of the plant and timestamp information;
analyze the annotated sensor data; and
determine a state of the plant based on the annotated sensor data; and
a lighting controller configured to:
control at least one of the plurality of lighting elements based on the determined state of the plant and a user input.

2. The system of claim 1, further comprising the lighting controller associated with the processor, wherein the lighting controller is configured to receive the user input comprising a lighting effect corresponding to the state of the plant and control at least one of the plurality of lighting elements to provide the lighting effect based on the user input.

3. The system of claim 1, wherein the processor is further configured to:
receive, from the plurality of sensors, initial sensor data for the at least one parameter of the plant; and
automatically determine the location information based on the initial sensor data received.

4. The system of claim 1, wherein the processor is further configured to:
receive an image of the plant; and
receive, from a user, the location information indicative of the relative locations of the plurality of sensors within the image.

5. The system of claim 1, wherein the plurality of sensors are contact-based sensors.

6. The system of claim 1, wherein the plurality of sensors are ultrasonic sensors.

7. The system of claim 1, wherein the processor is configured to classify the state of the plant based on a time-series classification algorithm.

8. A method for controlling plant lighting, the method comprising the steps of:
determining or receiving location information indicative of relative locations of a plurality of sensors arranged around a portion of a plant using a commissioning process, wherein the plurality of sensors are distributed among a plurality of lighting elements and the plurality of sensors are configured to capture sensor data for at least one parameter of the plant;
measuring, by the plurality of sensors, sensor data for the at least one parameter of the plant;
annotating, by a processor, the sensor data with the location information of the plurality of sensors, one or more parts of the plant and timestamp information;
analyzing, by the processor, the annotated sensor data from the plurality of sensors;
determining, by the processor, a state of the plant based on the annotated sensor data; and
controlling, by a lighting controller, at least one of the plurality of lighting elements based on the determined state of the plant and a user input.

9. The method of claim 8, further comprising the steps of:
receiving, by the lighting controller, the user input comprising a lighting effect corresponding to the state of the plant; and
controlling, by the lighting controller, at least one of the plurality of lighting elements based on the user input.

10. The method of claim 8, wherein the determining or receiving step comprises:
collecting, by the plurality of sensors, initial sensor data for the at least one parameter of the plant; and
automatically determining the location information based on the initial sensor data collected.

11. The method of claim 8, wherein the determining or receiving step comprises:
receiving an image of the plant; and
receiving, from a user, the location information indicative of relative locations of the plurality of sensors within the image.

12. The method of claim 8, wherein the measuring step comprises measuring the sensor data with contact-based sensors.

13. The method of claim 8, wherein the measuring step comprises measuring the sensor data with ultrasonic sensors.

14. The method of claim 8, wherein the step of determining the state of the plant comprises classifying the state of the plant based on a time-series classification algorithm.

15. The method of claim 8, further comprising the steps of:
receiving the user input comprising a lighting effect corresponding to an aggregation of a plurality of states of the plant, the plurality of states of the plant comprising the state of the plant; and
controlling, by the lighting controller, at least one of the plurality of lighting elements based on the user input.
